(19) United States
(12) Patent Application Publication
(10) Pub. No.: US 2004/0050682 A1
(43) Pub. Date: Mar. 18, 2004

(54) Activated water apparatus and methods and products

(76) Inventors: George Paskalov, Torrance, CA (US); Mark Gorodkin, Los Angeles, CA (US); Viktor Sokolov, Sherman Oaks, CA (US)

Correspondence Address: Rutan & Tucker, LLP, Suite 1400, 611 Anton Blvd., Costa Mesa, CA, 92626, US

(21) Appl. No.: 10/464,286

(22) Filed: Jun. 17, 2003

Related U.S. Application Data
(63) Continuation-in-part of application No. PCT/US02/41006, filed on Dec. 20, 2002.
(63) Continuation-in-part of application No. PCT/US01/49310, filed on Dec. 20, 2001.
(60) Provisional application No. 60/389,546, filed on Jun. 17, 2002.
(60) Provisional application No. 60/258,208, filed on Dec. 27, 2000.

(51) Int. Cl. C02F 1/30; B01J 19/08

(52) U.S. Cl. 204/157.15; 422/186.04; 134/2

(57) ABSTRACT

A radio wave generator is used to produce activated water or other activated fluids, having extreme acidity or alkalinity. Activated water of low pH can be advantageously marketed and used as a bactericidal agent. Activated water of high pH can advantageously be ingested, and marketed as bottled water. Activated water or other fluids can be used in numerous commercial processes.

This application is a CEP of PCT/US02/41006 filed on Dec. 20, 2002 which claims priority to a) PCT/US01/49310 filed on Dec. 20, 2001, which claims priority to 60/258208 filed on Dec. 27, 2000 and b) provisional application 60/389546 filed on Jun. 17, 2002.

### FIELD OF THE INVENTION

The field of the invention is activated fluids, including high and low pH water.

### BACKGROUND

Liquid and solid forms of water apparently exist in nature not as independent molecules of H₂O, but as clusters of approximately 10-24 molecules of H₂O. Obviously monomolecular water can exist transiently in liquids, as intermediates during and immediately following some chemical reactions, and in near vacuums. However, in any substantial quantity of non-gaseous water, the tendency of water to form such clusters is considerable. Current theory provides that the clusters are held together by large numbers of hydrogen bonds that are constantly being formed and destroyed. Water clusters are thought to vary in size depending on numerous factors that affect the hydrogen bonding.

Small cluster (SC) water is herein defined to have a mean size of only 5-6 water molecules per cluster. Electrical, magnetic, chemical, and acoustical methods have all been utilized in producing small cluster water: Electrical and magnetic methods typically involve running water past closely spaced electrodes. Examples are set forth in U.S. Pat. No. 5,387,324 (February 1995) and U.S. Pat. No. 6,165,339 (December 2000), both to Ibbott. Usually field strength is adjusted by moving the electrodes or magnets with respect to one another. See, e.g., U.S. Pat. No. 5,866,010 to Bogatin et al. (February 1999). In other instances field strength is adjusted by altering the path of the water. See e.g. U.S. Pat. No. 5,656,171 to Strachwitz (August 1997), which describes curved piping through magnetic field. U.S. Pat. No. 6,033,678 (March 2000) and U.S. Pat. No. 5,711,950 (January 1998) both to Lorenzen, describe production of reduced cluster water by passing steam across a magnetic field.

Chemical methods typically involve adding electrolytes and polar compounds. The U.S. Pat. No. 5,824,353 patent to Tsunoda, et al. teaches production of reduced cluster size water using a potassium ion concentration of 100 ppm or more, and containing potassium ions, magnesium ions and calcium ions in a weight ratio of potassium ions : magnesium ions : calcium ions of 1:0.3-4.5:0.5-8.5. Other chemical methods include use of surfactants, and clathrating structures that cause inclusion of one kind of molecules in cavities or lattice of another. See U.S. Pat. No. 5,997,590 to Johnson et al. (issued December 1999).

Acoustical methods typically involve subjection of water to supersonic sound waves. See U.S. Pat. No. 5,997,590 to Johnson et al. (issued December 1999).

A Japanese company currently sells a water purifying system that is said to produce water having cluster size of 5-6 molecules. The system, marketed under the name Microwater™, passes tap water past electrodes. Water passing closer to a positive electrode tends to become acidic. The company's literature reports that the acidic water (termed oxidized or hyperoxidized water) is said to be useful as an oxidizing agent to sterilize cutting boards and treat minor wounds. Other suggested uses are treating athlete's foot, minor bums, insect bites, scratches, bedsores and post-operative wounds. The company's literature also reports that the acidic water has been used agriculturally to kill fungi and other plant diseases. Water passing closer to a negative electrode tends to become alkaline. The alkaline water (termed reduced water) is said to be beneficial when taken internally. Such water is said to inhibit excessive fermentation in the digestive tract by indirectly reducing metabolites such as hydrogen sulfide, ammonia, histamines, indoles, phenols, and scatols.

U.S. Pat. No. 5,624,544 to Deguchi et al. (April 1997) describes such a system. Deguchi et al. claim that oxidizing streams down to pH 4.5 and reducing streams up to pH 9.5 can be achieved on a continuous basis, but that waters having pH 2.5 to 3.2 or pH 11.5 to 12.5 cannot be produced continuously for a long period. It is thought that these limitations are due to the known methods and apparatus being incapable of efficiently reducing the cluster size below about 4 molecules per cluster.

Small cluster water is reported to have numerous useful characteristics. Among other things, small cluster water is said to provide: improved taste of foods; accelerated absorption of drugs and food through the digestive tract; and prevention of cancer due to reduced production of mutagens in the intestines and reduced activity of enteric microorganisms and digestive tract tissue cells. See U.S. Pat. No. 5,824,353 to Tsunoda et al. (October 1998). Tsunoda et al. and all other publications identified herein are incorporated by reference in their entirety.

Unfortunately, none of the known methods of producing activated water can do so efficiently and cost effectively. Therefore, there is still a need to provide methods and apparatus that can continuously produce substantial quantities of activated water or other fluids, in a cost effective manner.

### SUMMARY OF THE INVENTION

The present invention provides methods and apparatus for continuously producing activated water, which is defined herein as having pH of less than 4 or greater than 10. The terms “continuously producing” and “continuously produced” are used herein to mean that at least 800 ml/min of water having these characteristics can be produced by a single device over the course of at least one hour.

A preferred class of apparatus subjects water to waves from an RF plasma. The basic frequency of the plasma is preferably between 0.44 MHz and 40.68 MHz, and the plasma is preferably modulated at a frequency between 10 kHz and 34 kHz. Typically two outlets are used, one delivering acidic water having a measured pH of less than 4, and the other delivering alkaline water having a measured pH of greater than 10. Flow rates typically range from 20 l/hr to about 2000 l/hr, although multiple configurations and sizes of device are also contemplated, so that lower and higher flow rates are possible.

Activated water of low pH can be advantageously marketed and used as a bactericidal agent. Activated water of high pH can advantageously be ingested, and marketed as bottled water. Activated water or other fluids can be used in numerous commercial processes.

Systems and methods of conducting commercial process involving a transient extreme pH are also provided. The term “transient extreme pH” as referred to herein means that the pH level is at least 5 or 6 orders of magnitude away from normal (i.e. pH of 7 for water). The pH of the activated molecules is transient because the molecules are not stable at a higher or lower pH, and will tend to go toward their natural state after some period of time. It is further contemplated that fluids may be quasi-activated, meaning that the pH level is at least 4 orders of magnitude away from the native state. The term “native” referred to herein means a non-activated state, which for water is a pH of 7. Additionally, the term “activated fluid” as referred to herein means that the fluid is activated so that it has a transient extreme pH.

A preferred method comprises identifying the commercial process as involving a transient extreme pH; separating a fluid into a high extreme acidity stream and a low extreme acidity stream; and applying an amount of at least one of the fluid streams during the commercial process.

Activated water or other fluid can be used for many purposes. It is presently contemplated that substantially all types of commercially important chemical reactions may benefit from the addition of fluids having a transient pH. Those chemical reactions can be classified as follows: buffered reactions; oxidation/reduction reactions; crystallization processes; biological processes; non-biological processes; and all other chemical reactions or processes. Viewed from another perspective, contemplated commercial processes can be categorized into classes of applications in which use of a fluid having a transient pH would be beneficial. Those classes include: (1) transportation, handling, and storage; (2) activation energy of a reaction; (3) reactivity of a reaction; (4) kinetics of a reaction; (5) sanitation; (6) pollution; (7) cleaning; (8) extraction; (9) ion exchange; and (10) anti-corrosive effects.

Various objects, features, aspects, and advantages of the present invention will become more apparent from the following detailed description of preferred embodiments of the invention, along with the accompanying drawing.

### BRIEF DESCRIPTION OF THE DRAWINGS

FIG. 1 is a vertical cross section of an activated water generator.

### DETAILED DESCRIPTION

Apparatus

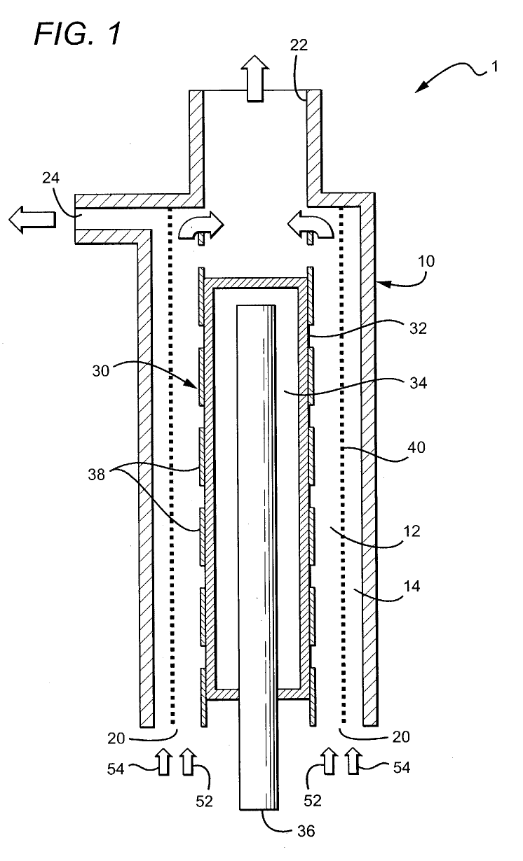

In FIG. 1 an activated water generator 1 generally includes a vessel 10 that has an inlet 20 and two outlets 22, 24, and that encloses a plasma generator 30. Plasmas are conductive assemblies of charged particles, neutrals and fields that exhibit collective effects. Plasma. generator 30 is preferably a “cold” type plasma device, which term is used herein to mean a gas of ionized atoms cooler than 10,000 °K. A membrane 40 disposed between the vessel 10 and the plasma generator 30 defines an inner space 12 and an outer space 14. With the plasma generator 30 in operation, a first stream 52 of water enters the vessel 10 at inlet 20, flows through inner space 12, and exits the vessel at outlet 22. A second stream 54 also enters the vessel 10 at inlet 20, but flows through outer space 14 and exits the vessel at outlet 24.

Vessel 10 can be any suitable size and shape, as long as water being treated is subjected to energy from the plasma under conditions that produce the desired characteristics in the treated water. Thus, although the vessel 10 in FIG. 1 is substantially cylindrical, with a circular cross-section, other suitable vessels may have a polygonal, oval or other horizontal cross section. Small units are contemplated, for example, where the vessel cavity is only about 200 ml or less. On the other hand large units are contemplated that have an internal volume of at least 10 l, as well as everything in between. Unless otherwise stated, ranges are deemed herein to be inclusive of the stated endpoints. Vessel 10 is preferably constructed of stainless steel 316 to reduce corrosion effects, although any sufficiently strong and resistant material could be used, including for example titanium, tantalum, stainless steel coated with titanium, molybdenum, platinum, iridium, and so forth. Multiple water generators can process water in parallel or series.

Water or other fluids can be subjected to the plasma radiation in any suitable manner. This can be advantageously accomplished by flowing water past the plasma generator 30, but can also be accomplished in a batch mode. For example, a plasma generator can be placed in a container of water, and removed when the water is sufficiently treated. Under those circumstances the system may be used to treat polluted water in situ, i.e. where the water is disposed in soil or some other substance. The pollution may be biological, in which case bacteria, viruses, helminthes, or other microorganisms would be killed or inactivated, or chemical, in which case a chemical could be rendered less harmful through oxidation or reduction, enzymatic destruction, and so forth. Alternatively, water can be treated in a batch mode, ex situ from where it is eventually used.

It is contemplated that the water being processed (i.e. activated) can have substantially any practical purity. It is preferred that water for processing comprise between about 95% H₂O and 99.99% H₂O, but waters having less than 95%, 90%, 85%, 80%, or even 50% are also contemplated. Tap water is thought to typically contain between about 95% H20 and 99.99% H₂O, and is considered to be a good source of water for processing. Distilled water is less suitable because it contains little or no dissolved salts. When processed water has some electro-conductivity it is easier to match plasma and water parameters using the standard matching network system. In this case RF power generator have maximum efficiency and reflected power is minimum.

In this particular example, the plasma generator 30 includes a quartz tube 32 that contains a gas 34 (not shown), an RF electrode 36, and a plurality of external electrodes 38. The tube 32 can be anywhere from about 60 mm to about 500 mm long or longer. The gas 34 is any suitable plasma gas, including for example argon, argon plus helium, argon plus neon, neon plus helium plus argon, and is held at low pressure, defined herein to mean less than 100 Torr. The gas used in the experimental device of FIG. 1 is Argon, and is filled at a pressure of about 10 Torr. Some experimental data are shown in the Table 1.

| | | | | | | | |
|---|---|---|---|---|---|---|---|
| Power | W/cm³ | 7.2 | 32.4 | 61.4 | 62 | 103 | 229 |
| ORP | mV | 780 | 1040 | 984 | 874 | 800 | 790 |
| pH | | 6.4 | 2.3 | 3.3 | 6.4 | 6.3 | 6.3 |

The plasma generator could alternatively be “open”,i.e. working pressure up to 1 atmosphere or enclosed at high working pressure, for instance up to 50 Atm.

The electrodes 36, 38 are preferably fabricated from the same type of material as the vessel 10, but are also contemplated to be fabricated from any other suitable material. A first voltage of 500V is applied across the RF electrode 36 and vessel 10, which is electrically grounded for safety and other reasons, to generate waves at a basic frequency of between 0.44 MHz and 40.68 MHz, and the resulting waves stimulate the gas 34 to become plasma. A second voltage of 100V (DC bias) is applied across the RF electrode 36 and external electrode 38 to separate the ions.

Those skilled in the art will recognize that numerous modifications can be made to the preferred embodiment of FIG. 1, while still producing a plasma. For example, the quartz tube can be replaced by Pyrex™, and the external electrodes 38 can be more or less in number than that shown, and can be spaced differently. External electrode 38 should be perforated to allow radiation to escape to the water. Other base and modulation frequencies can be utilized, so long as the resulting plasma provides energy of sufficient frequency and power to achieve the desired effects on water passing through the vessel 10.

Membrane 40 is permeable to ions, but within that limitation the membrane 40 can be made from many different types of materials. Both high-porous and low-porous materials are contemplated, including ceramic materials based on silica, zirconium oxide, yttrium oxide, and so forth. Some porosity is needed to allow ion exchange to achieve pH gradient. In the experimental version of FIG. 1, the membrane was approximately 300 mm long, which is about 20% longer than the plasma chamber.

The membrane 40 is separated from the plasma generator 30 and the vessel 10 by gaps dimensioned in accordance with the power of the plasma generator 30 and the design flow rate of the system. In the experimental version of FIG. 1, the gap from membrane 40 to plasma generator 30 is 2.5 mm, and the gap from membrane 40 to vessel 10 is approximately 1.5 mm. The flow rate of water through vessel 10 (i.e. through the inlet and exiting either outlet) and is approximately 7 l/min.

The membrane 40 preferably extends substantially the entire length of the external electrodes 38, but can be shorter or longer, and is actually not entirely necessary. The main purpose of the membrane 40 is to separate low pH water from high pH water, so that they exit from different outlets. If that separation is not important a single outlet (not shown) can be used, and the membrane 40 can be eliminated. Benefits can still be achieved, however, because the processed water can still have reduced cluster size, and it is known that activity of water increases as the cluster size is reduced. Very small cluster (VSC) water is defined herein to mean water that has a mean cluster size of less than 4 water molecules per cluster, and is considered to be very active. The term “mean cluster size” is used herein to mean an arithmetic average of cluster sizes in a volume of water. Monomolecular (MM) water is defined herein to mean water that has a mean cluster size of less than 2 molecules per cluster, and is considered to be extremely active. Both VSC and MM waters are much more active that normal water (10-24 molecules per cluster) or even SC water (5-6 molecules per cluster).

Additionally, the plasma reactor runs at atmospheric pressure. However, it is contemplated that the plasma reactor could run at any pressure from vacuum to extremely high pressures, but may simply run at atmospheric pressure.

Contemplated gases used in the plasma reactor include any gas typically found in the environment. Particularly contemplated plasma gases include AR, He, Ne, O₂, N₂, H₂, Air, Carbon Dioxide, and CH₄, or any combination thereof.

Processing Considerations

Those skilled in the art will recognize that the apparatus of FIG. 1 can be scaled up or down. For example, the apparatus of FIG. 1 can alternatively be viewed as having an overall length of about 100 cm, with the membrane/plasma generator gap being about 7 mm, and the membrane/vessel gap being about 3 mm. Such a device could continuously produce VSC or MM water at a rate of at least 1200 liters/hour. Moreover, even larger devices are contemplated.

When used to activate water, the plasma in FIG. 1 preferably operates at or close to a frequency that breaks apart water clusters. In theory such frequency should vary somewhat depending on the impurities present in the water being treated, and that is precisely what is found. Tap waters from several cities around the United States have been used as sources for experiments, and it is found that a given modulation frequency produces disparate results. The active water generator 1 is therefore preferably “tuned” to improve the breakup of the clusters, and such tuning can advantageously be accomplished by varying the modulation frequency and bias voltage while viewing the output of a ORP meter measuring oxidation reduction potential of one of the processed water streams exiting the vessel 10. Breakup of clusters is considered to be optimized by seeking to maximize a positive measured potential or minimize a negative measured potential. In experiments the activity of New York City tap water appears to be optimized at a modulation frequency of approximately 22.7 kHz. The activity of Chicago area tap water appears to be optimized at a modulation frequency of approximately 21.6 kHz. The activity of Los Angeles city tap water appears to be optimized at a modulation frequency of approximately 21.0 kHz. There, when the external electrodes 38 were biased by a negative voltage, the processed water exiting outlet 22 was demonstrated to have pH from 1.8 to 4, ORP from +900 mV to +1150 mV and cluster size was estimated to be from 1 to 3 molecules per cluster. When the external electrodes 38 were biased by a positive voltage, the processed water exiting outlet 22 was demonstrated to have pH from 9 to 11, ORP from −680 mV to +100 mV and cluster size was again estimated to be from 1 to 3 molecules per cluster.

Experimental results establish that at room temperature, water treated in accordance with the teachings herein can remain “activated” for several hours after it is created, but then revert back to normal water within at most a day or two. That reversion process, which may be followed over time as pH deterioration, can be delayed by lowering the temperature of the water. Freezing appears to prevent the “activated” water from reverting back to normal water by at least several weeks. Reversion of the acidic water to normal water can be prevented by adding crystalline clay minerals. See U.S. Pat. No. 5,624,544 to Deguchi et al. (April 1997). Activated water can also be stabilized using a metasilicate salt stabilizer. See U.S. Pat. No. 6,033,678 (March 2000) to Lorenzen. Of course, use of the water as a bactericidal agent or in other ways “uses up” the special qualities, and can destroy such qualities almost immediately.

Water is not, however, the only fluid that can be activated. A great many types of fluids may be activated according to the methods and apparatus described herein. Fluids can be classified according to their polarity. Examples of contemplated polar fluids include but are not limited to water, liquid ammonia, alcohols such as ethanol, dimethyl sulfoxide, acetone and acetic acid. Non-polar fluids that can be activated according to contemplated methods include benzene, hydrocarbons, non-polar chlorinated hydrocarbons, petroleum ether, hexane, or any other non-polar fluid.

Contemplated Uses

One of the significant advantages of using an RF generator to produce activated water or other fluids is that the process is very efficient. The cost of production is quite low relative to other methods, and that low cost opens up a whole range of domestic and commercial opportunities that were previously impractical from a cost standpoint.

For example, water having a high pH can be ingested by animals and humans to beneficial effect. Among other things, water having a high pH can be bottled, and sold for sports enthusiasts or other health conscious individuals. Such water is preferably bottled at a pH of at least 9, and more preferably at least 10. Surprisingly, such water can retain a relatively high pH (at least 8) for at least two days, and more preferably for at least seven, fourteen, or 30 days. It is especially contemplated that such bottled water will be advertised as being high pH water, by labeling or otherwise. Such bottled water is preferably, but not necessarily, manufactured using an RF generator as described above.

In commercial manufacturing processes, activated fluids, such as that produced by the methods above, may be used to affect the structure of a molecule, conformation of a molecule, or intermolecular forces between molecules. It should also be appreciated that activated fluids are also contemplated to affect coordinate covalent bonds between a Lewis acids and Lewis bases. Moreover, activated fluids may affect reactions in which hydrogen ions and/or hydroxide ions are reactants and/or products of the reaction. Other examples include reactions in which hydrogen ions and/or hydroxide ions are reactants and/or products of the reaction. For example, hydroxide ions (or other anionic species created using the methods described above) may be used as nucleophilic reactants to form a bond. In still another example, hydrogen ions (or other cationic species created using the methods described above) may be used as electrophilic reactants.

Water or any other molecule produced by the methods contemplated above may be used as a solvent or co-solvent in several types or classes of reactions. Typical examples include reactions in which the solvent or co-solvent provides an increased or decreased proton or hydroxyl ion content. Such solvents or co-solvents may be particularly useful in reduction/oxidation and electrolysis reactions, creating ion exchange gradients, precipitation reactions, solubility reactions, salt formation reactions, buffers, titrations, crystallization processes, biological and non-biological processes, reactions involving chromatography, electrophoresis, and reactions involving at least one enzyme or catalyst.

Contemplated commercial uses include, but are not limited to: (1) transportation, handling, and storage; (2) activation energy of a reaction; (3) reactivity of a reaction; (4) kinetics of a reaction; (5) sanitation; (6) pollution; (7) cleaning; (8) extraction; (9) ion exchange; and (10) anti-corrosive effects.

(1) Transportation, Handling, and Storage

Highly acidic and basic compounds are often used in chemical laboratories, pharmaceutical laboratories, and various manufacturing facilities. Those compounds, solutions, or chemicals are often difficult to store, transport, and handle. For example, 16 M hydrochloric acid is extremely combustible and flammable. Also, the fumes emitted from the compounds, as well as the compounds themselves, are harmful to humans and animals. Skin is prone to being severely burned if it is exposed to solutions having an extreme pH. Additionally, nostril membranes are readily burned from the fumes of a very acidic or basic compound.

Using activated fluids in place of highly acidic or basic compounds tends to overcome at least some of the dangers of transporting, storing, and handling such compounds. Activated fluids may be produced on site as needed using the apparatus and methods described in FIG. 1. After a period of time, the activated fluid will revert back to a more neutral pH, which can then be transported, stored, and/or handled safely.

(2, 3, & 4) Activation Energy, Reactivity, and Kinetics of a Reaction Activated fluids can be used to overcome the activation energy of a reaction. Activated fluids can also affect the reactivity of a reaction as well as the kinetics of a reaction. Since contemplated fluids have a transient pH, adding that fluid to a pH dependent reaction may drive that reaction either forward or backward (to product or educt).

Viewed from another perspective, adding a fluid having a transient extreme high or low pH to a chemical reaction may affect either the energy given off from a reaction, or the energy needed to drive a reaction. For example, adding a fluid having a transient extreme high or low pH to a chemical reaction may be sufficient to overcome the activation energy, such as typically occurs through the use of a catalyst or enzyme. In another example, a large amount of heat may be given off if a highly acidic molecule is combined with a highly basic molecule. That heat may then be captured and converted to other types of energy. After a period of time, the fluid will revert to a more neutral pH. That eliminates the need to add other solutions to dilute or neutralize the reaction after the reaction is driven to completion. For example, if a strong acid is added to a reaction to overcome an activation energy, after the reaction is driven to completion, the solution is often neutralized. Use of activated fluids in this manner eliminates the last step of having to neutralize or dilute the solution because the activated fluid will automatically change, or normalize, to a more neutral pH.

(5, 6, & 7) Sanitation, Cleaning, and Pollution

Strong acids and bases are often used for sanitation purposes. For example, hospitals, medical or doctors' offices, equipment, work tables, rest rooms and other public places including public buildings and facilities, floors, walls, tools, instruments, knives, agricultural areas, food packaging and manufacturing plants, pharmaceutical research and manufacturing centers etc. may use strong acids and bases to kill bacteria, fungi, viruses, and other germs or pollutants. Especially contemplated surfaces that can advantageously be treated include those in hospitals and other medical facilities, as well as rest rooms and other areas where blood, feces, or urine may be present.

To be effective as an antibacterial agent, it is preferred that at least 50% of the bacteria would be killed or inactivated within 45 seconds of application, although it is more preferable that at least 70%, 80% or even 90% of the bacteria would be killed or inactivated within 1 minute of application. Alkaline-waters, especially those having pH or at least 10, are considered useful because of their reducing properties. Thus, such waters may be useful in food processing because they help to retard deterioration of discoloration caused by oxidation. The ability to retard deterioration may be useful in promoting health in humans and other animals when ingested. Such waters may also be advantageously used in watering plants.

Additionally, strong acids and bases are often used to clean surfaces to remove dirt and grime. For example, pools and tiles are often cleaned with murionic acid. Additionally, strong bases are often used to un-clog pipes and drains.

However, using strong acids and bases in those ways is dangerous because strong acids and bases are often flammable, combustible, and dangerous to skin. One way to solve this problem is to use activated fluids, which have extremely high or low pH for a period of time, and then become safer by changing to a more neutral pH.

Another drawback to using strong acids and bases is the problem of disposing those chemicals, which often results in pollution to the environment. Allowing strong acids and bases to run off into drain pipes or seep into the land hurts the environment, including the underground water supply, oceans and rivers, and plant and animal species. Using activated fluids will be safer to the environment by reducing pollution because the fluids revert to a more neutral pH after a specific time.

Moreover, activated fluid may be especially useful in the field of electronics and computers. Contemplated fluids may be used to clean circuits and other electronic equipment from dust, debris, and any other undesirable contaminants. Desirable fluids for cleaning electronic circuits or computers are acidic and leave little to no residue. For example, an alcohol compound may be activated and used to clean such circuitry or other electronics, and then would evaporate, leaving no residue.

A further example is using activated fluid to neutralize toxic spills in the environment, such as on land or in the ocean. Typically, strong acids and bases are used to neutralize toxic spills but that is problematic because the excess acid or base is left in the environment. By using activated fluids, the excess fluid will revert to a neutral pH, and thus is less likely to harm the environment.

### Example of Disinfection or Other Treatment of Fluids

In a particular aspect, contemplated configurations and methods may be particularly useful in the treatment and especially disinfection of fluids, and particularly waste fluids. For example, FIG. 2 generally depicts a RF plasma disinfection system that processes fluids, including waste fluids. Contemplated plasma disinfection systems utilize plasma reactors to treat fluids by placing the fluids in an environment that subjects the fluids to electromagnetic fields, heat, and/or wide spectrum light radiation. In preferred embodiments, the plasma reactor creates an environment in which UV radiation is used to treat substances.

The contemplated plasma disinfection systems could be of any type. However, it is preferred that the plasma disinfection system is capacitive, inductive, or a hybrid. It is further contemplated that the base and modulation frequency can range from 0 (CW) to 150 kHz.

In a particularly preferred embodiment, water, or other contemplated fluid, is run through an RF plasma disinfection system. However, it is contemplated that all fluids may be run through the system. In additional embodiments, waste liquid flows around the plasma between RF electrodes and is disinfected via exposure to plasma spectrum radiation, including UV radiation, and to pulsed electromagnetic fields.

(8 & 9) Extraction and Ion Exchange

Activated fluids having a transient pH can be used in extraction processes of chemical compounds. For example, activated fluids can be used in place of the strong acids normally used in precipitation reactions, such as the one that is typically used to isolate estrogen (Premarin™) from horse urine.

Activated fluids can also be used in ion exchange processes. For example, electroplating and minerals mining typically requires use of a strong acid. However, problems arise regarding the disposal of those strong acids, and discharges into waters of acids must typically be monitored. Treatment of acid mine drainage often includes neutralization of acidity and precipitation of metal ions to meet relevant effluent limits through the use of chemicals. Use of activated fluids can eliminate at least some of those problems because the activated fluids will have a neutral pH by the time they are disposed of in the environment.

(10) Anti-corrosive Effects

Using activated fluids can also have anti-corrosive effects. For example, the system can be used to disinfect fluids utilized for ballast, such as ballast water. Ballast water is any material used to weight and/or balance an object. Currently, although ballast water is essential for safe and efficient shipping operations, it poses serious ecological, economic, and health problems. However, by using the systems and methods disclosed herein, many of the problems associated with the use of ballast water in shipping may be avoided, and it may become more economically feasible to use activated water.

Additional Examples

As discussed above, activated fluids can be used in ionic reactions, buffered reactions, biological processes and non-biological processes.

Ionic reactions typically involve cations and anions that dissociate in solution. An example of a typical ionic reaction is:

HCl(aq)+NaOH(aq)→Na⁺+Cl⁻+H₂O (1).

A buffered solution is typically defined as a solution that resists a change in its pH when either hydroxide ions or protons are added. An example of a buffered reaction is:

HCl+NaHCO₃→NaCl+H₂CO₃ and H₂CO₃+NaOH→NaHCO₃+H₂O

Many biological processes and reactions require an enzyme catalyst. Enzymes are biological catalysts that generally mediate biochemical reactions. Enzymes differ from ordinary chemical catalysts in the following ways: enzymes tend to produce higher reaction rates, enzymatic reactions require milder reaction conditions, enzymes have vastly greater degrees of specificity with respect to the identities of their substrates and their products; and enzymatic reactions can be regulated by such processes as allosteric control, covalent modification of enzymes, and variation of the amounts of enzymes synthesized.

The following illustrates a typical example of an enzymatic reaction. Alpha-D-glucose can convert to beta-D-glucose in the presence of an enzyme catalyst, such as phenol (a weak benzene-soluble acid) together with pyridine (a weak benzene soluble base).

Additionally, activated fluids may be added to commercial processes such as the manufacturing of pharmaceutical compounds. Generally, the solubility of a compound decreases as the compounds reach the isoelectric point. However, it is often desirable to have increased solubility of compounds. Decreasing the pH of the solution will tend to increase the solubility of a cationic form of a compound, whereas increasing the pH of a solution will tend to decrease the solubility of the anionic form of a compound. Thus, acidified water, or any other molecule produced by the methods contemplated above, may be employed to increase solubility without forming a salt. Similarly, basic water or other molecule, may be employed to form the free base of an acid. For example, if carboxamidine is placed in acidic conditions, the reaction will be driven to the protonated form of the carboxamidine. Similarly basic activated fluid can be employed to form the free base of an acid. As another example, if EDTA (free form) is placed in basic conditions, the reaction will be driven to the deprotonated form of EDTA.

Contemplated non-biological reactions include but are not limited to precipitation reactions, salt formation reactions, blots (i.e. southern blot), ion exchange columns, electroplating and minerals mining.

Precipitation reactions involve two or more solutions that are mixed together to form an insoluble substance that separates from solution. A typical precipitation reaction is AgNO₃+HCl→AgCl(s)+HNO₃, where AgCl separates out of solution.

Ion exchange resins typically consist of polymers that have many ionic sites. The process of softening water involves the use of an ion exchange resin in the process of softening water. Residential water supplies often contain excess amounts of calcium and magnesium ions, which can be removed by an ion exchange resin. When hard water is passed through a cation exchange resin, calcium and magnesium cations bind to the resin. Activated water or other molecule produced by the methods contemplated above may be used in an exchange column that needs acid or base regeneration, such as the process of softening water. For example, acidified water or other fluid may be used to displace cations from a cationic exchange resin. Similarly, basic water or other fluid may be employed to replace anions from an anion exchange resin.

Electroplating of metals is typically performed by immersing a conductive surface in a solution containing ions of the metal to be deposited. The surface is electrically connected to an external power supply, and current is passed through the surface into the solution. This causes reaction of the metal ions (Mz-) with electrons (e-) to form metal (M):

Mz-+ze-→M

For example, a silicon wafer may be coated with a thin conductive layer of copper (seed layer) and immersed in a solution containing cupric ions. Electrical contact is made to the seed layer, and current is passed such that the reaction Cu₂⁺+2e-→Cu occurs at the wafer surface. The wafer, electrically connected so that metal ions are reduced to metal atoms, is referred to as the cathode. The anode (another electrically active surface), is present in the conductive solution to complete the electrical circuit. At the anode, an oxidation reaction occurs that balances the current flow at the cathode, thus maintaining electrical neutrality in the solution. In the case of copper plating, all cupric ions removed from solution at the wafer cathode are replaced by dissolution from a solid copper anode.

The southern blot is a procedure used to identify a specific base sequence of DNA. Typically, this procedure involves gel electrophoresis of double-stranded DNA, followed by soaking the gel containing the double stranded DNA in 0.5 M NaOH solution, which converts the DNA to the single stranded form. A sheet of nitrocellulose paper is then placed over the gel, and the gel is blotted through the nitrocellulose so that the single-stranded DNA binds to it at the same position it had in the gel. Activated fluid having a transient high pH can be used in this procedure to replace the NaOH solution, thus eliminating at least some of the problems of working with strong bases.

There are several techniques used for materials mining, such as mineral mining, gold mining, silver mining, etc. One method of mineral mining is dredging, which involves mixing large amounts of water with crushed ore to allow the heavier minerals to settle to the bottom (e.g. tin, mineral sands).

Electrolysis can then be used to extract extremely reactive metals, such as sodium and aluminum from the ore by passing an electric current through an ionic solution (e.g. seawater) or a molten liquid (e.g. molten alumina Al₂O₃). For example, sodium chloride in seawater is placed in a container with two carbon electrodes and an electric current is passed through the liquid. The positively charged sodium metal ions are attracted to the negatively-charged electrode (cathode). The negative chlorine ions are attracted to the positively-charged electrode (anode) and chlorine gas bubbles off.

Thus, specific embodiments and applications of very small cluster (VSC) and monomolecular (MM) water have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. An apparatus comprising:
a radio wave generator that produces waves at a radio frequency; and
a processing vessel that includes a first water flow path that subjects a first portion of a stream of water entering the vessel to the waves in such manner as to produce a first stream of processed water that exits the vessel at a pH of less than 4 or greater than 10.

2. The apparatus of claim 1 further includes a second water flow path distinct from the first flow path, which subjects a second portion of the stream of water to the waves in such manner as to produce a second stream of processed water that exits the vessel at a pH of less than 4 or greater than 10.

3. The apparatus of claim 1, wherein the first flow path is sized and dimensioned to pass the first stream of water at a rate of at least 1000 liter/hr.

4. The apparatus of claim 1 wherein the frequency is between 10 kHz and 34 kHz.

5. The apparatus of claim 1 wherein the wave generator comprises a plasma generator.

6. The apparatus of claim 5 wherein the plasma generator produces a cold plasma having a basic frequency of between 0.44 MHz and 40.68 MHz.

7. The apparatus of claim 6 wherein the plasma is subjected to a modulation frequency between 10 kHz and 34 kHz.

8. The apparatus of claim 1 wherein the first water flow path further subjects the first portion of the stream of water to the waves for sufficient time such that the first stream exits the vessel with a mean cluster size of less than 4 molecules per cluster.

9. The apparatus of claim 1 wherein the first water flow path further subjects the first portion of the stream of water to the waves for sufficient time such that the first stream exits the vessel with a measured Oxidation Reduction Potential of less than −350 mV or greater than +800 mV.

10. A bottled water wherein the water has a measured pH of at least 10, and retains a pH of at least 8 over a period of at least two days.

11. A method of marketing, comprising advertising a bottled water of claim 10 as high pH water.

12. A method of cleaning a surface having a bacterial population, comprising:
subjecting water to a radio frequency energy source that alters a measured pH of the water to less than 4; and
applying the altered water to the surface under conditions that kill at least 80% of the bacterial population.

13. The method of claim 10 wherein the water is further subjected to the radio frequency source to such an extent that the water is altered to a measured pH of less than 2.5.

14. A method of conducting a commercial process comprising:
identifying the commercial process as involving a transient extreme pH;
separating a fluid into a first stream having a transient high extreme acidity stream and a second stream having a transient low extreme acidity stream; and
applying an amount of at least one of the fluid streams during the commercial process, wherein the commercial process is not primarily directed to manufacturing the high extreme acid fluid or the low extreme acid fluid.

15. The method of claim 14, wherein the fluid is substantially a polar fluid.

16. The method of claim 15, wherein the fluid is substantially water.

17. The method of claim 14, wherein the fluid is substantially waste water.

18. The method of claim 14, wherein the commercial process affects an ionic structure of a molecule.

18. The method of claim 14, wherein the commercial process comprises an oxidation/reduction reaction.

19. The method of claim 14, wherein the commercial process comprises an enzymatic reaction.

20. The method of claim 14, wherein the commercial process comprises a pharmaceutical manufacturing process.

21. The method of claim 14 wherein the commercial process comprises a precipitation reaction.

22. The method of claim 14, wherein the commercial process comprises an ion exchange column.

23. The method of claim 14, wherein the commercial process comprises electroplating.

24. The method of claim 14, wherein the commercial process comprises materials mining.

25. The method of claim 14, wherein the fluid of the applied stream loses its extreme acidity within 30 minutes following the step of applying.
